(19) United States
(12) Patent Application Publication
(10) Pub. No.: US 2006/0077823 A1
(43) Pub. Date: Apr. 13, 2006

(54) SYSTEM AND METHOD FOR AUTOMATICALLY CALIBRATING LIGHT EMITTING DEVICE

(76) Inventors: Shang-Pin Sun, Hsin-Chu County (TW); Kun-Yi Chan, Changhua County (TW)

Correspondence Address: NORTH AMERICA INTELLECTUAL PROPERTY CORPORATION, P.O. BOX 506, MERRIFIELD, VA, 22116, US

(21) Appl. No.: 10/711,836

(22) Filed: Oct. 8, 2004

(51) Int. Cl. G11B 19/00; G11B 5/09

(52) U.S. Cl. 369/47.5; 369/53.1

(57) ABSTRACT

A method of automatic light emitting device calibration includes providing an optical device having a light emitting device and a photo monitor; controlling power of the light emitting device by changing values of a drive signal to the light emitting device; detecting light emitted by the light emitting device and generating a monitor signal having a value corresponding to the light emitted by the light emitting device utilizing the photo monitor; and determining a preliminary power relationship relating values of the drive signal to powers of the light emitting device according to received monitor signal values for a plurality of drive signal values and a predetermined conversion rule for converting the received monitor signal values to corresponding powers of the light emitting device. A final power relationship is generated by performing a power relationship correction operation to ensure test data is written to an optical medium at a particular power.

### BACKGROUND

The invention generally relates to optical recording and storage drives, and more particularly, to a system and a method for automatically calibrating the proper output power of a light emitting device.

As requirements for high volume storage mediums continue to increase, optical discs (for example, CDs and DVDs) are playing a more important role. During the manufacturing process, pits are created on the optical discs by an optical pickup unit (OPU) of the optical disc recorder by emitting a light beam on the optical disc. Lands are formed on the optical disc when no light beam is emitted thereon. Pits have a lower reflectivity than the lands, and each pit and each land represent information of 0 and 1, respectively.

However, pits produced by laser beams of different output power levels from different optical disc recorders are usually shaped differently, which causes difficulty in the process of reproducing the recorded information. This is a result of the variation in the assembly of the OPU and inconsistencies in the photo diode properties. Therefore, the optical disc recorder has to have its laser power calibrated prior to the fab-out stage so that the OPU can provide laser beams of the correct power.

FIG. 1 shows a power calibration system 100 as disclosed by Liu, et al. in published U.S. Patent application No. 2003/0208332A1. Referring to FIG. 1, the power calibration system 100 is used for calibrating a laser diode 102 of the optical recording drive 104 (Jason: Numeral 104 is not shown in FIG. 1. Please add.), wherein the laser diode 102 is positioned within an optical recording drive 104. The optical recording drive 104 comprises an optical disc plate 106, which can move in and out of the optical recording drive 104. A first module 108 is positioned upon the laser diode 102 in order to receive the laser beam from laser diode 102. The second module 110 is coupled to the first module 108 and a computer 112, and the computer 112 is coupled to the first module 108 and the optical recording drive 104.

Although not shown, the power calibration system 100 requires the application of a standard photo diode to be used with the power calibration system, in addition to requiring control to be performed by the computer 112. These requirements significantly increase the manufacture costs. Additionally, in order to command the laser diode 102 of the optical recording drive 104 to progressively emit light beams of increasing power levels, the optical recording drive 104 must be equipped with some kind of a digital port to receive the commands from the computer 112. In PC related applications (for example, CD-R/RW drive, DVD-R/RW drive, DVD+R/RW drive, . . . etc.), an ATAPI interface is typically used for this purpose. However, in order to reduce costs, in consumer electronic applications, the optical disc recorders (for example, CD-R/RW recorder, DVD recorder, . . . etc) are generally not equipped with ATAPI interfaces because such interfaces are not needed during normal operations. Therefore an improved light emitting device calibration method for the laser diode of optical disc drives, optical disc recorders, and other products having light emitting devices is required.

### SUMMARY

One objective of the invention is therefore to provide a method for automatic calibration of a light emitting device not requiring external test equipment or an external computer to thereby solve the above-mentioned problems.

According to an exemplary embodiment of the invention, a method is disclosed for automatic light emitting device calibration comprising the following steps: providing an optical device having a light emitting device and a photo monitor; controlling power of the light emitting device by changing values of a drive signal to the light emitting device; detecting light emitted by the light emitting device and generating a monitor signal having a value corresponding to the light emitted by the light emitting device utilizing the photo monitor; and determining a preliminary power relationship relating values of the drive signal to powers of the light emitting device according to received monitor signal values for a plurality of drive signal values and a predetermined conversion rule for converting the received monitor signal values to corresponding powers of the light emitting device.

According to another exemplary embodiment of the invention, an auto-calibrating optical device is disclosed comprising: a light emitting device to be calibrated; a photo monitor for detecting light emitted by the light emitting device and generating a monitor signal having a value corresponding to the light emitted by the light emitting device; and a microprocessor coupled to the light emitting device and the photo monitor for controlling power of the light emitting device by changing values of a drive signal to the light emitting device; and for during a calibration mode, determining a preliminary power relationship relating values of the drive signal to powers of the light emitting device according to received monitor signal values for a plurality of drive signal values and a predetermined conversion rule for converting the received monitor signal values to corresponding powers of the light emitting device.

These and other objectives of the invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a power calibration system according to the related art.

FIG. 2 is a block diagram of an auto-calibrating optical device according to a first exemplary embodiment of the present invention.

FIG. 3 is a signal diagram of how the monitor signal values outputted by the signal monitor change according to the drive signal values of the microprocessor of FIG. 2.

FIG. 4 is a graph illustrating a predetermined rule for converting monitor signal values to power values by the microprocessor of FIG. 2.

FIG. 5 is a graph illustrating the preliminary power relationship determined by the microprocessor of FIG. 2.

FIG. 6 is a graph illustrating how the microprocessor of FIG. 2 corrects the preliminary power relationship to thereby generate the final power relationship.

FIG. 7 is a flowchart describing a method of automatic light emitting device calibration according an exemplary embodiment of the present invention.

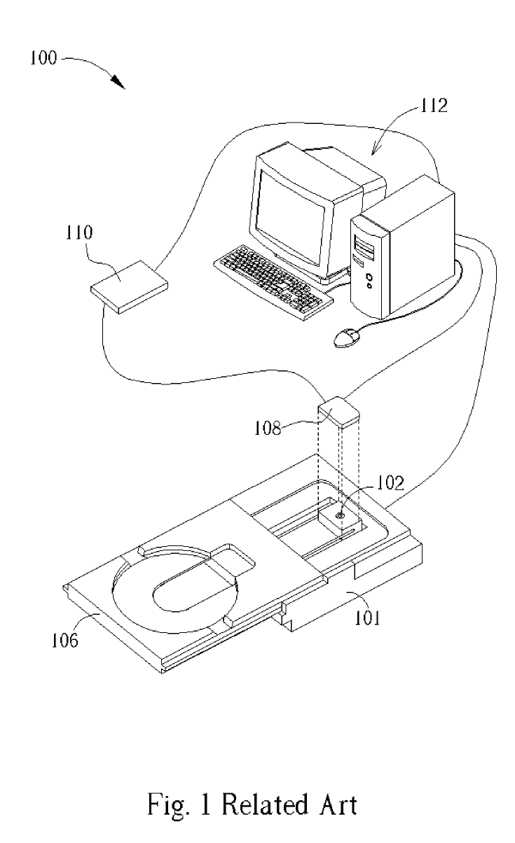

### DETAILED DESCRIPTION

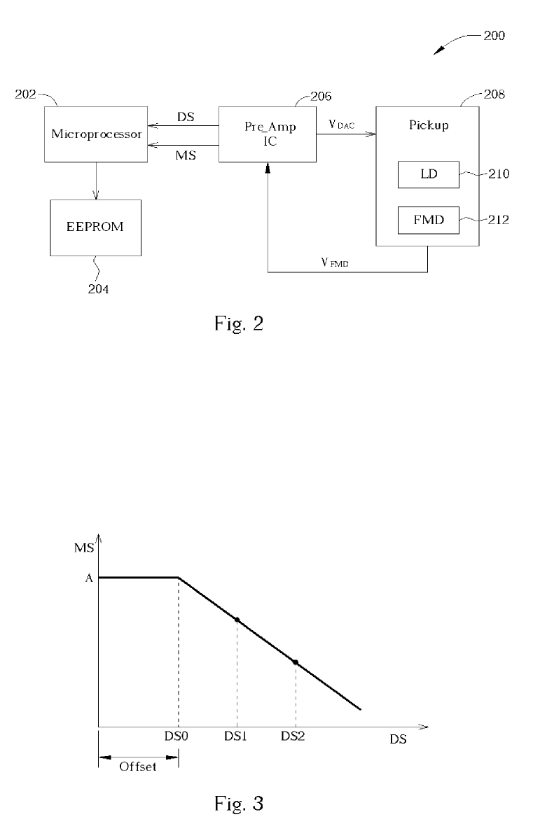

FIG. 2 shows a block diagram of an auto-calibrating optical device 200 according to a first exemplary embodiment of the present invention. The optical device 200 includes a microprocessor 202, an electrically erasable programmable read only memory (EEPROM) 204, and a pre-amplifier integrated circuit (IC) 206, and a pickup module. The pickup module 208 includes a laser diode (LD) 210 and a front monitor diode (FMD) 212. The LD 210 is the light emitting device automatically calibrated during a calibration mode by the optical device 200. The microprocessor 202 is coupled to the LD 210 and the FMD 212 through the pre-amplifier IC 206. In this embodiment, in addition to amplification, the pre-amplifier IC 206 converts a digital drive signal DS outputted by the microprocessor 202 to an analog control voltage V_{DAC}, and converts an analog front monitor signal V_{FMD} to a digital monitor signal MS, which is passed to the microprocessor 202. The microprocessor 202 uses the drive signal DS for controlling power of the LD 210 by changing values of the drive signal DS to the pre-amplifier IC 206. The analog control voltage V_{DAC} is thereby changed and different powers of light from the LD 210 are thereby emitted. The FMD 212 is for detecting the light emitted by the LD 212 and generating the front monitor signal V_{FMD} having a value corresponding to the intensity of the light emitted by the LD 210. The FMD 212 is a commonly used component included in optical disc drives of the related art for performing automatic power control (APC) during normal operations.

After assembly at the manufacturer, the optical drive 200 performs automatic calibration of the laser power of the LD 211. Power is applied to the optical device 200 and the microprocessor 202 enters a calibration mode. For example, a jumper in the device under test 200 could be set to control the microprocessor 202 to enter the calibration mode, or other methods such as temporally loading program code corresponding to the calibration mode into the EEPROM 204 for execution by the microprocessor 202 at power-on. Once in the calibration mode, the microprocessor 202 controls the output power of the LD 210 by changing values of the drive signal DS to the pickup module 208. A plurality of different values of the drive signal DS are outputted by the microprocessor 202. The pre-amplifier IC 206 drives the pickup module to control the LD 210 at different output power levels corresponding to the different values of the drive signal DS. Light emitted by the LD 210 is sensed by the FMD 212 and the monitor signal MS corresponding to the front monitor signal V_{FMD} is passed to the microprocessor 202. The microprocessor 202 then utilizes a predetermined conversion rule for converting the received monitor signal MS values to corresponding powers of the LD 210, and thereby determines a preliminary power relationship relating values of the drive signal DS to powers of the light emitted by the LD 210.

FIG. 3 shows a signal diagram of how the monitor signal values outputted by the signal monitor change according to the drive signal values of the microprocessor of FIG. 2. The front monitor signal V_{FMD} has an inversely proportional voltage with respect to the power of light emitted by the LD 210. As shown in FIG. 3, because of the light emitting properties of the LD 210, for lower values of the drive signal DS there is no light emitted from the LD 210. This is indicated by a constant monitor signal MS value A. After a particular offset of the lower drive signal DS values, at drive signal value DS0, the drive signal values are large enough to turn on the LD 210 and light emitted by the LD 210 and detected by the FMD 212 causes the monitor signal MS to begin to drop in value. As the drive signal DS values increase, the received monitor signal MS values decrease.

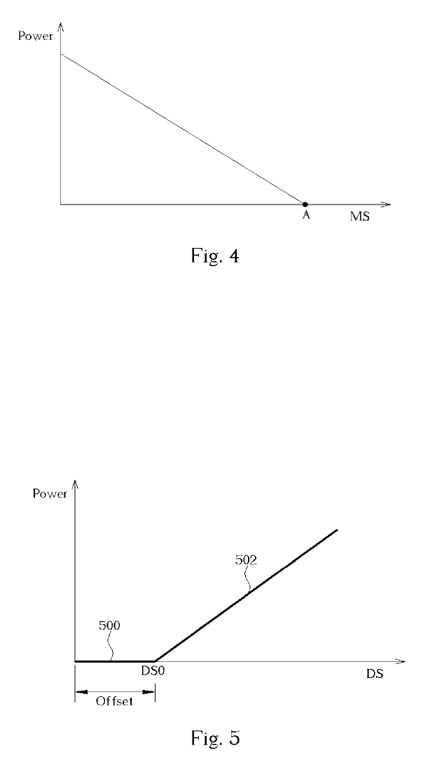

FIG. 4 shows a graph illustrating a predetermined rule for converting monitor signal values to power values by the microprocessor of FIG. 2. At monitor signal MS at a value of A, there is zero power of the LD 210. For lower values of the monitor signal MS, the power increases according to the predetermined rule. The microprocessor 202 uses the predetermined rule shown in FIG. 4 to convert the received monitor signal MS values corresponding to drive signal DS values being higher than the offset value DS0 to power values to thereby generate the preliminary power relationship.

FIG. 5 is a graph illustrating the preliminary power relationship determined by the microprocessor of FIG. 2. For values of the drive signal DS within a lower offset, there is no light emitted from the LD 210. This offset is shown as a first portion 500 of the power relationship having zero power. At drive signal value DS0, the LD 211 begins to emit light and, during a second portion 502, the power relationship ramps upward in laser power as the drive signal DS values increase.

In this embodiment, the microprocessor 202 progressively increases the values of the drive signal DS; however, the present invention is not limited to only this embodiment. For example, if the slope of the second portion 402 of the power curve is assumed to be linear, calibration of the LD 210 can be performed using only two values (e.g., DS1 and DS2) of the drive signal DS. More specifically, the microprocessor 202 controls the power of the LD 210 by utilizing a first drive signal value DS1 and a second drive signal value DS2. A first monitor signal value is received corresponding to the first drive signal value DS1, and a second monitor signal value is received according to the second drive signal value DS2. The microprocessor 202 then extrapolates monitor signal values in a line formed between the first received monitor signal value and the second received monitor signal value. In order to determine the offset value DS0 of the drive signal, the microprocessor 202 determines a crossing value of the drive signal corresponding to where the extrapolated monitor signal values of the line cross the predetermined value A of the monitor signal when the LD 210 is not emitting any light. Finally, the microprocessor 202 converts the extrapolated monitor signal MS values of the line corresponding to drive signal DS values being higher than the offset value DS0 to power values according to the predetermined conversion rule to thereby generate the preliminary power relationship.

At this point, the preliminary power relationship determined by the microprocessor 202 is sufficiently accurate to be used to control the read power of the LD 210. However, there is a uncertainty (for example, approximately 10% value variation) between particular front monitor signals V_{FMD} of different FMDs 212 of different optical drives 200. Because the write laser power of the LD 210 is desired to be controlled precisely in order to ensure accurate pit creation during the recording phase of an optical disc, in a preferred embodiment of the present invention, the preliminary power relationship is further corrected using a power relationship correction operation. The power relationship correction operation is performed on an optical disc of the optical device 200 during the automatic calibration process at the manufacture. During the automatic calibration process, the microprocessor 202 controls the optical drive 200 to write test data to an optical disc of the optical device 202 using a particular drive signal DS value for a predetermined power value. The preliminary power relationship (FIG. 5) is used by the microprocessor 202 to determine the value of the drive signal DS to use for the predetermined power value. The microprocessor 202 then reads a read signal corresponding to the test data from the optical disc. Finally, the microprocessor 202 analyzes the read signal to determine if the test data was written to the optical disc at the particular power. According to the result of the analysis, the preliminary power relationship is correspondingly adjusted such that the test data is written to the optical disc at the predetermined power. One or more iterations of the power relationship correction operation could be performed to thereby obtain a final power relationship having an accurate drive signal to LD 210 power values for the particular FMD 212.

There are various implantations of the power relationship correction operation. One example is the Optimum Power Control (OPC) process commonly performed by optical disc drives of the related art before recording information on an optical disc. Because different optical discs have different optimal laser write power requirements, the OPC process is used by the related art optical devices to optimize the write power of the laser diode according to a specified optimal power requirement for particular optical disc. Typically, the OPC process is performed by the related art optical devices in an OPC section of the optimal disc. The OPC section must be used because the OPC process involves writing test data to the optical disc that if not written in the OPC section, would interfere with user data stored on the optical disc. As the OPC process is well known to a person of ordinary skill in the art, further description of the specific operations of the OPC process is omitted herein. However, it should also be noted that in this embodiment, because the present invention uses the OPC process as the power relationship correction operation that is performed at the manufacturer, there is no concern with interfering with user data stored on the optical disc. Therefore, the power relationship correction operation can be a modified OPC process being performed in any section of the optical disc.

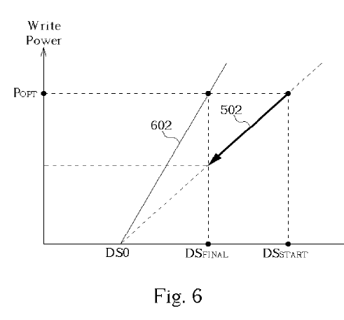

FIG. 6 shows a graph illustrating how the microprocessor 202 corrects the preliminary power relationship according to the results of the power relationship correction operation. Firstly, the microprocessor uses the preliminary power relationship to determine a starting value DS_{START} of the drive signal DS for an optimal power P_{OPT} predetermined by an optical disc used during the automatic calibration. The power relationship correction operation is performed starting at the starting value DS_{START} to determine if the starting value DS_{START} correctly causes a laser power equal to the optimal power P_{OPT}. In the example graph shown in FIG. 6, due to the approximately 10% variation in front monitor diode voltages V_{FMD} between different devices, the starting value DS_{START} produces a power of value greater than the optimal power P_{OPT}. Using the power relationship correction operation, such as an OPC process shown as an example in FIG. 6, a final value DS_{FINAL} of the drive signal is determined. The final value DS_{FINAL} produces a LD 210 power equal to the optimal power P_{OPT}. Because the offset value DS0 is known, and because the second portion of the final power relationship curve 602 can be assumed to be linear, the slope of the second portion 502 of the preliminary power relationship can be adjusted to thereby generate the second portion 602 of the final power relationship. In this way, the microprocessor 202 adjusts the preliminary power relationship such that test data of the power relationship correction operation is written to the optical disc at the predetermined power P_{OPT} to thereby generate the final power relationship.

The final power relationship is then stored in the non-volatile memory EEPROM 204 and automatic calibration is completed. During normal operations, the final power relationship stored in the EEPROM 204 is used for controlling values of the drive signal DS according to desired powers of the light emitting device. For example, the final power relationship can be used to provide a starting value for the OPC process for writing operations to different optical discs. Because the final power relationship is optimized for the particular FMD 212 of the optical drive 200, the OPC process for recording operations performed during normal user mode operations could be completed much faster.

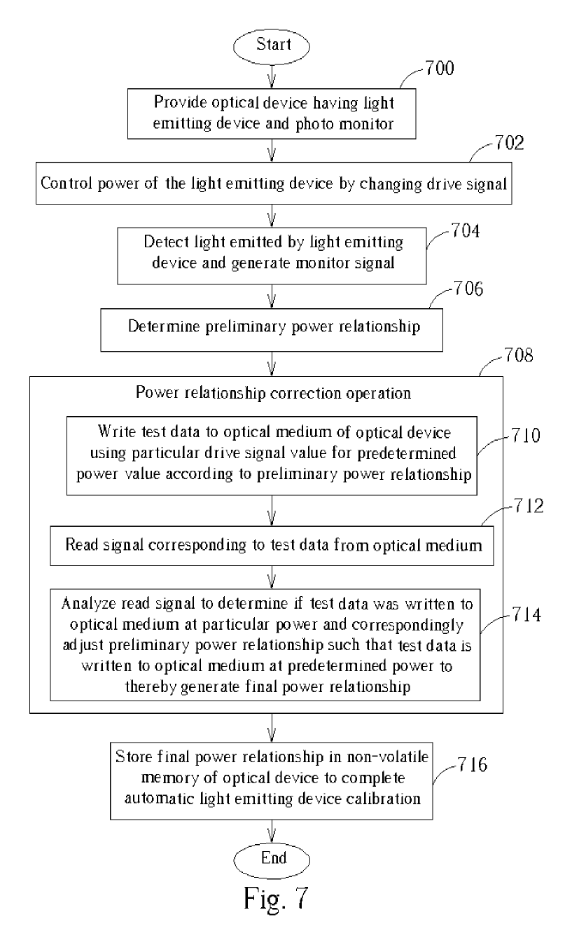

FIG. 7 is a flowchart describing a general method of automatic light emitting device calibration according to an exemplary embodiment of the present invention. The automatic calibration method according to the present invention is not limited specifically to laser diodes and can be used to calibrate other light emitting devices. Additionally other photo monitors such as light sensors can be used instead of the front monitor diode. Automatic light emitting device calibration according to this exemplary embodiment comprises the following steps:

Step 700: Provide an optical device having a light emitting device and a photo monitor.

Step 702: Control the power of the light emitting device by changing values of a drive signal to the light emitting device.

Step 704: Detect light emitted by the light emitting device and generate a monitor signal having a value corresponding to the light emitted by the light emitting device utilizing the photo monitor.

Step 706: Determine a preliminary power relationship relating values of the drive signal to powers of the light emitting device according to received monitor signal values for a plurality of drive signal values and a predetermined conversion rule for converting the received monitor signal values to corresponding powers of the light emitting device. The preliminary power relationship is sufficiently accurate to be used to control the read power of the light emitting device. However, because the write laser power of the light emitting device is preferred be controlled precisely in order to ensure an accurate recording phase, in a preferred embodiment of the present invention, the preliminary power relationship is further corrected using a power relationship correction operation at step 708.

Step 708: Generate a final power relationship by performing a power relationship correction operation on an optical medium of the optical device. The power relationship correction operation includes steps 710-714. One or more iterations of the power relationship correction operation (step 708) could be performed to thereby obtain a final power relationship having an accurate drive signal to LD 210 power values for the particular FMD 212.

Step 710: Write test data to the optical medium of the optical device using a particular drive signal value for a predetermined power value according to the preliminary power relationship.

Step 712: Read a read signal corresponding to the test data from the optical medium.

Step 714: Analyze the read signal to determine if the test data was written to the optical medium at the particular power and correspondingly adjust the preliminary power relationship such that the test data is written to the optical medium at the predetermined power to thereby generate the final power relationship.

Step 716: Store the final power relationship in a non-volatile memory of the optical device to complete the automatic light emitting device calibration. During normal operations, control values of the drive signal to control the power of the light emitting device according to the final power relationship stored in the non-volatile memory.

The present invention provides an auto-calibrating optical device and associated method of automatic light emitting device calibration that does not require control from an external computer, an expensive power meter, or any other external test equipment. Manufacturing costs are therefore greatly reduced. Additionally, because the calibration process is controlled by a microprocessor embedded in the auto-calibrating optical device, the calibration process is simplified and easily automated. Furthermore, as the optical device performs automatic calibration without receiving signals from outside the optical device, no interface port needs to be installed on the optical device. The present invention is therefore well suited for use with both PC-related optical drives (such as CD-R/RW drives, DVD-R/RW drives, DVD+R/RW drives . . . , etc.) and consumer electronic optical devices (such as CD-R/RW recorders, DVD recorders, . . . etc.) having no external interface port.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of automatic light emitting device calibration for an optical device having a light emitting device and a photo monitor, comprising the following steps:
controlling power of the light emitting device by changing values of a drive signal to the light emitting device;
detecting light emitted by the light emitting device and generating a monitor signal having a value corresponding to the light emitted by the light emitting device utilizing the photo monitor; and
determining a preliminary power relationship relating values of the drive signal to powers of the light emitting device according to received monitor signal values for a plurality of drive signal values and a predetermined conversion rule for converting the received monitor signal values to corresponding powers of the light emitting device.

2. The method of claim 1, wherein determining the preliminary power relationship relating the values of the drive signal to the powers of the light emitting device comprises the following steps:
determining an offset value being a maximum value of the drive signal where the light emitting device does not emit light according to the received monitor signal values; and
converting the received monitor signal values corresponding to drive signal values being higher than the offset value to power values according to the predetermined conversion rule to thereby generate the preliminary power relationship.

3. The method of claim 2, wherein determining the preliminary power relationship relating the values of the drive signal to the powers of the light emitting device further comprises the following steps:
controlling the power of the light emitting device by utilizing a first drive signal value and a second drive signal value;
extrapolating monitor signal values of a line formed between a first received value of the monitor signal corresponding to the first drive signal value, and a second received value of the monitor signal corresponding to the second drive signal value;
determining the offset value of the drive signal to be a crossing value of the drive signal corresponding to where the extrapolated monitor signal values of the line cross a predetermined value of the monitor signal when the light emitting device is not emitting any light; and
converting the extrapolated monitor signal values of the line corresponding to drive signal values being higher than the offset value to power values according to the predetermined conversion rule to thereby generate the preliminary power relationship.

4. The method of claim 1, further comprising generating a final power relationship by performing a power relationship correction operation on an optical medium of the optical device; the power relationship correction operation comprising the following steps:
writing test data to the optical medium of the optical device using a particular drive signal value for a predetermined power value according to the preliminary power relationship;
reading a read signal corresponding to the test data from the optical medium; and
analyzing the read signal to determine if the test data was written to the optical medium at the particular power and correspondingly adjusting the preliminary power relationship such that the test data is written to the optical medium at the predetermined power to thereby generate the final power relationship.

5. The method of claim 4, wherein the power relationship correction operation involves performing an optimum power control (OPC) on the optical medium of the optical device.

6. The method of claim 5, further comprising performing the OPC using a non-OPC area of the optical medium.

7. The method of claim 4, further comprising storing the final power relationship in a non-volatile memory of the optical device; and during normal operations, controlling values of the drive signal to control the power of the light emitting device according to the final power relationship stored in the non-volatile memory.

8. The method of claim 1, wherein the optical device is an optical disc drive or an optical disc recorder, the photo monitor is a front monitor diode (FMD), and the light emitting device is a laser diode.

9. The method of claim 8 being used to configure the write power or the read power of the laser diode.

10. An auto-calibrating optical device comprising:
a light emitting device to be calibrated;
a photo monitor for detecting light emitted by the light emitting device and generating a monitor signal having a value corresponding to the light emitted by the light emitting device; and
a microprocessor coupled to the light emitting device and the photo monitor for controlling power of the light emitting device by changing values of a drive signal to the light emitting device; and for during a calibration mode, determining a preliminary power relationship relating values of the drive signal to powers of the light emitting device according to received monitor signal values for a plurality of drive signal values and a predetermined conversion rule for converting the received monitor signal values to corresponding powers of the light emitting device.

11. The auto-calibrating optical device of claim 10, wherein to determine the preliminary power relationship relating the values of the drive signal to the powers of the light emitting device, the microprocessor determines an offset value being a maximum value of the drive signal where the light emitting device does not emit light according to the received monitor signal values; and converts the received monitor signal values corresponding to drive signal values being higher than the offset value to power values according to the predetermined conversion rule to thereby generate the preliminary power relationship.

12. The auto-calibrating optical device of claim 11, wherein to determine the preliminary power relationship relating the values of the drive signal to the powers of the light emitting device, the microprocessor further controls the power of the light emitting device by utilizing a first drive signal value and a second drive signal value; extrapolates monitor signal values of a line formed between a first received value of the monitor signal corresponding to the first point, and a second received value of the monitor signal corresponding to the second drive signal value; determines the offset value of the drive signal to be a crossing value of the drive signal corresponding to where the extrapolated monitor signal values of the line cross a predetermined value of the monitor signal when the light emitting device is not emitting any light; and converts the extrapolated monitor signal values of the line corresponding to drive signal values being higher than the offset value to power values according to the predetermined conversion rule to thereby generate the preliminary power relationship.

13. The auto-calibrating optical device of claim 10, wherein the microprocessor is for further generating a final power relationship by performing a power relationship correction operation on an optical medium of the optical device; the power relationship correction operation comprising the microprocessor writing test data to the optical medium of the optical device using a particular drive signal value for a predetermined power value according to the preliminary power relationship; reading a read signal corresponding to the test data from the optical medium; and analyzing the read signal to determine if the test data was written to the optical medium at the particular power and correspondingly adjusting the preliminary power relationship such that the test data is written to the optical medium at the predetermined power to thereby generate the final power relationship.

14. The auto-calibrating optical device of claim 11, wherein the power relationship correction operation involves the microprocessor performing an optimum power control (OPC) on the optical medium of the optical device.

15. The auto-calibrating optical device of claim 12, wherein the microprocessor performs the OPC using a non-OPC area of the optical medium.

16. The auto-calibrating optical device of claim 11, further comprising a non-volatile memory for storing the final power relationship determined by the microprocessor during the calibration mode, the final power relationship being used by the microprocessor during normal operations for controlling values of the drive signal according to desired powers of the light emitting device.

17. The auto-calibrating optical device of claim 10, wherein the optical device is an optical disc drive or a optical disc recorder, the photo monitor is a front monitor diode (FMD), and the light emitting device is a laser diode.

18. The auto-calibrating optical device of claim 17 being capable of calibrating the write power or the read power of the laser diode.
